(19) United States
(12) Patent Application Publication
(10) Pub. No.: US 2020/0049796 A1
(43) Pub. Date: Feb. 13, 2020

(54) EFFICIENT NEAR FIELD RADAR MATCH FILTER PROCESSING

(71) Applicant: GM GLOBAL TECHNOLOGY OPERATIONS LLC, Detroit, MI (US)

(72) Inventors: Oded Bialer, Petah Tivak (IL); Amnon Jonas, Jerusalem (IL); Samuel Kolpinizki, Raanana (IL)

(21) Appl. No.: 16/100,335

(22) Filed: Aug. 10, 2018

(51) Int. Cl. G01S 7/295; G01S 13/93; G01S 13/42

(52) U.S. Cl. CPC G01S 7/295; G01S 2013/0245; G01S 13/42; G01S 13/931

(57) ABSTRACT

A vehicle, radar system and method of operating a radar is disclosed. The radar system includes a radar array and a processor. The radar array includes at least a first radar node and a second radar node, with each of the first radar node and the second radar node having a plurality of subnodes. The processor determines a first far-field parameter measurement for an object for a first node of the radar using sub-nodes of the first node, determines a second far-field parameter measurement for the object for a second node of the radar using sub-nodes of the second node, and obtains a joint parameter measurement for the object by combining the first far-field parameter measurement with the second far-field parameter measurement by correcting for a near-field phase difference between the first node and the second node.

### INTRODUCTION

The subject disclosure relates to a radar system and method of use and, in particular, to methods for achieving an angular resolution of a radar signal in a radar array using match filtering.

A radar system can be implemented on a vehicles in order to detect objects in the path of the vehicle, allowing the vehicle to navigate with respect to the objects. The radar system can include a plurality of radar nodes at separated locations about the vehicle. Such a radar system forms a wide aperture radar which can provide a low resolution. Match filtering can be used for a wide aperture radar to increase the resolution. However, straightforward implementation of a match filter is complex, since different elements in the array observe each reflection point at different ranges, angles and Doppler frequencies due to variations in near-field measurements. Accordingly, it is desirable to provide an efficient and practical method of applying a match filter to a signal in a wide aperture radar in a near-field scenario.

### SUMMARY

In one exemplary embodiment, a method of operating a radar is disclosed. The method includes determining a first far-field parameter measurement for an object for a first node of the radar using sub-nodes of the first node, determining a second far-field parameter measurement for the object for a second node of the radar using sub-nodes of the second node, and obtaining a joint parameter measurement for the object by combining the first far-field parameter measurement with the second far-field parameter measurement by correcting for a near-field phase difference between the first node and the second node.

In addition to one or more of the features described herein, the first node and the second node of the radar form a near-field aperture, the subnodes of the first node form a far-field aperture and the subnodes of the second node form a far-field aperture. The method further includes determining first coarse grid parameter measurements for a first match filter associated with the first node and determining second coarse grid parameter measurements for a second match filter associated with the second node. The method further includes interpolating the first coarse grid parameter measurements to estimate the first far-field parameter measurement at grid location on a first fine grid and interpolating the second coarse grid parameter measurements to estimate the second far-field parameter measurement at a grid location on a second fine grid. Correcting for the near-field phase difference further includes applying a near-field correction with respect to a selected location to the first far-field parameter measurement and the second far-field parameter measurement. The method further includes performing at least one of (i) range FFT; (ii) Doppler FFT; (iii) beamforming to determine at least one of the first far-field parameter measurement and the second far-field parameter measurement. The method further includes navigating a vehicle with respect to the object using the joint parameter measurement.

In another exemplary embodiment, a radar system is disclosed. The radar system includes a radar array and a processor. The radar array includes at least a first radar node and a second radar node, each of the first radar node and the second radar node having a plurality of subnodes. The processor is configured to determine a first far-field parameter measurement for an object for a first node of the radar using sub-nodes of the first node, determine a second far-field parameter measurement for the object for a second node of the radar using sub-nodes of the second node, and obtain a joint parameter measurement for the object by combining the first far-field parameter measurement with the second far-field parameter measurement by correcting for a near-field phase difference between the first node and the second node.

In addition to one or more of the features described herein, the first node and the second node of the radar form a near-field aperture, the subnodes of the first node form a far-field aperture and the subnodes of the second node form a far-field aperture. The processor is further configured to determine first coarse grid parameter measurements for a first match filter associated with the first node and determine second coarse grid parameter measurements for a second match filter associated with the second node. The processor is further configured to interpolate the first coarse grid parameter measurements to estimate the first far-field first parameter measurement at a grid location on a first fine grid and interpolate the second coarse grid parameter measurements to estimate the second far-field parameter measurement at a grid location on a second fine grid. The processor is further configured to applying a near-field correction with respect to a selected location to the first far-field parameter measurement and the second far-field parameter measurement. The processor is further configured to perform at least one of (i) range FFT; (ii) Doppler FFT; (iii) beamforming to determine at least one of the first far-field parameter measurement and the second far-field parameter measurement. The processor is further configured to navigate a vehicle with respect to the object using the joint parameter measurement.

In yet another exemplary embodiment, a vehicle is disclosed. The vehicle includes a radar array and a processor. The radar array includes at least a first radar node and a second radar node, each of the first radar node and the second radar node having a plurality of subnodes. The processor is configured to determine a first far-field parameter measurement for an object for a first node of the radar using sub-nodes of the first node, determine a second far-field parameter measurement for the object for a second node of the radar using sub-nodes of the second node, obtain a joint parameter measurement for the object by combining the first far-field parameter measurement with the second far-field parameter measurement by correcting for a near-field phase difference between the first node and the second node, and navigate the vehicle with respect to the object using the joint parameter measurement.

In addition to one or more of the features described herein, the first node and the second node of the radar form a near-field aperture, the subnodes of the first node form a far-field aperture and the subnodes of the second node form a far-field aperture. The processor is further configured to determine first coarse grid parameter measurements for a first match filter associated with the first node and determine second coarse grid parameter measurements for a second match filter associated with the second node. The processor is further configured to interpolate the first coarse grid parameter measurements to estimate the first far-field first parameter measurement at a grid location on a first fine grid and interpolate the second coarse grid parameter measurements to estimate the second far-field parameter measurement at a grid location on a second fine grid. The processor is further configured to apply a near-field correction with respect to a selected location to the first far-field parameter measurement and the second far-field parameter measurement. The processor is further configured to perform at least one of (i) range FFT; (ii) Doppler FFT; (iii) beamforming to determine at least one of the first far-field parameter measurement and the second far-field parameter measurement.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle with an associated trajectory planning system in accordance with various embodiments;

FIG. 2 shows an illustrative embodiment of a radar array for the vehicle of FIG. 1;

FIG. 3 illustrates the effect of aperture size on signal detection at a radar array;

FIG. 4 shows a two-node array including a first node and a second node separated from each other;

FIG. 5 illustrates a far-field processing for estimating a parameter measurement of an object using a second node of the array of FIG. 4;

FIG. 6 illustrates a method for obtaining a joint parameter measurement from the first far-field parameter measurement and the second far-field parameter measurement; and

FIG. 7 shows a flowchart illustrating a method of vehicle navigation using the methods disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

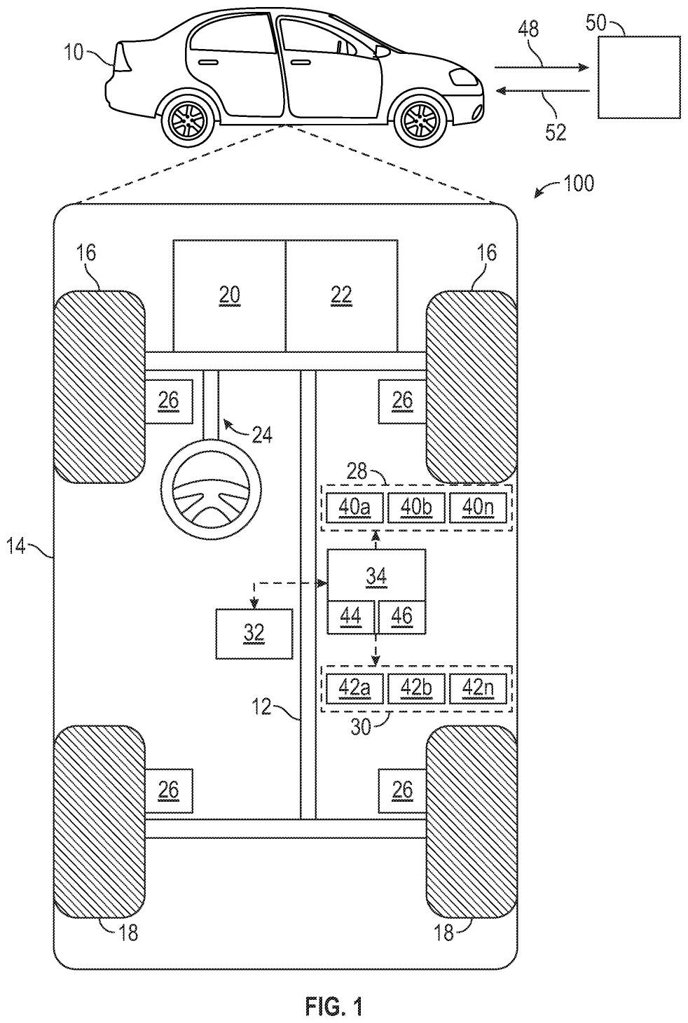

In accordance with an exemplary embodiment, FIG. 1 shows a vehicle 10 with an associated trajectory planning system depicted at 100 in accordance with various embodiments. In general, the trajectory planning system 100 determines a trajectory plan for automated driving of the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near respective corners of the body 14.

In various embodiments, the vehicle 10 is an autonomous vehicle and the trajectory planning system 100 is incorporated into the autonomous vehicle 10 (hereinafter referred to as the autonomous vehicle 10). The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In various embodiments, the vehicle 10 includes a radar system including an array of radar sensors, the radar sensors of the radar array being located at various locations along the vehicle 10. In operation, a radar sensor sends out an electromagnetic pulse 48 that is reflected back at the vehicle 10 by one or more objects 50 in the field of view of the sensor.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as ventilation, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The trajectory planning system 100 navigates the autonomous vehicle 10 based on a determination of objects and/their locations within the environment of the vehicle. In various embodiments the controller 34 operates a plurality of radars at various locations on the vehicle 10 to determine a location (i.e., range, elevation and azimuth) of the object 50 using interpolation of far-field responses using a correction for near-field assumptions of the responses. The determined location can be used either alone or in combination with similar parameters obtained by single radar systems in order to provide range, azimuth and/or elevation of the object 50 for navigation purposes. Upon determining various parameters of the object, such as range, azimuth, elevation, velocity, etc., the controller 34 can operate the one or more actuator devices 42a-n, the propulsion system 20, transmission system 22, steering system 24 and/or brake 26 in order to navigate the vehicle 10 with respect to the object 50.

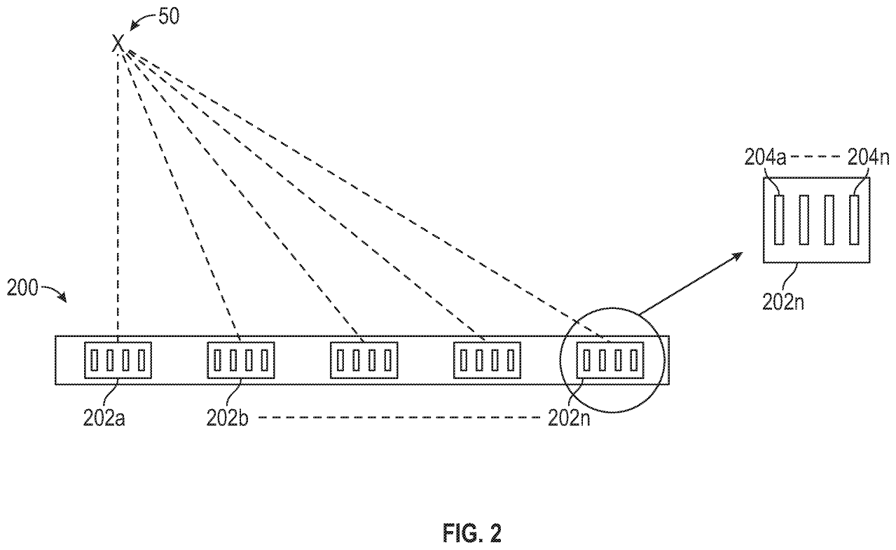

FIG. 2 shows an illustrative embodiment of a radar array 200 for the vehicle 10 of FIG. 1. The radar array 200 is a wide aperture radar including a plurality of radar nodes 202a, 202b, . . . , 202n. For illustrative purposes, the radar array 200 of FIG. 2 includes five radar nodes. Each radar node 202a, . . . , 202n includes a plurality of subnodes having a small aperture. Radar node 202n is expanded to show in detail a plurality of subnodes 204a, . . . , 204n. For illustrative purposes, the selected radar node 202n includes four subnodes. However, any number of subnodes can be included in a node and any number of nodes can be included in a radar array 200. In general, each node will have the same number of subnodes as the other nodes of the radar array 200. The subnodes are generally radar antennae or radar transceivers of the radar system 200.

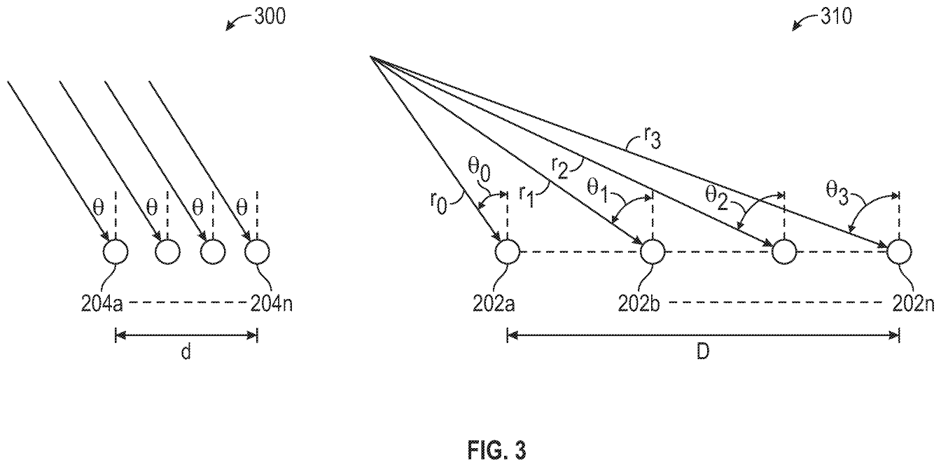

FIG. 3 illustrates the effect of aperture size on signal detection at a radar array. The relative aperture size determines whether near-field equations or far-field equations are applicable. A far field scenario is generally defined by when the distance to the object is greater than 2D²/λ, where D is the length of the array and λ is the wavelength of the test signal for the radar. First radar array 300 illustrates a far-field spacing. Second radar array 310 illustrates a near-field spacing. In various embodiments, the first array 300 is representative of the subnodes 204a, . . . , 204n of FIG. 2 and the second array 310 is representative of the nodes 202a, . . . , 202n of FIG. 2.

The aperture d of the subnode array is the distance spanned by the subnodes 204a, . . . , 204n. Due to the relatively small size of the aperture d, the subnodes 204a, . . . , 204n are considered to receive signals in a far-field scenario for which the object is considered to be at infinity. For a small aperture of about 10 cm, and a wavelength of 4 mm the far-field conditions apply to objects that are at a distance of greater than about 5 meters. In the far-field scenario, the angles of arrival at each subnode are the same or substantially the same. Similar the range measured obtained from correlation of the signal waveform (and not from the carrier phase measurement) at each subnode is the same or substantially the same, as are Doppler measurements at each sub node. There is therefore a relatively simple relation between the reflection point position and the phase, range and Doppler measurements at each sub node 204a . . . , 204n.

The second radar array 310 shows a near-field spacing between nodes 202a, . . . , 202n spanning an aperture D. For the near-field spacing of array 300, the angles of arrival (θ₀, θ₁, θ₂, θ₃) are different for each node. Similarly, the ranges (r₁, r₂, r₃, r₄) are different for each node, and the Doppler measurements are all different from each other. There is therefore a complex relation between the reflection point position and the measured phases, ranges, and Doppler frequencies at the nodes.

Methods disclosed herein determine radar parameters of an object, such as range, Doppler and angle, by first obtaining a far-field estimate of the parameter using measurements at subnodes of a node. Then, the far-field estimates are combined across the nodes of the array. Combining the far-field estimates includes applying a near-field correction based on the spacing of the nodes of the array. These methods are discussed in further details below.

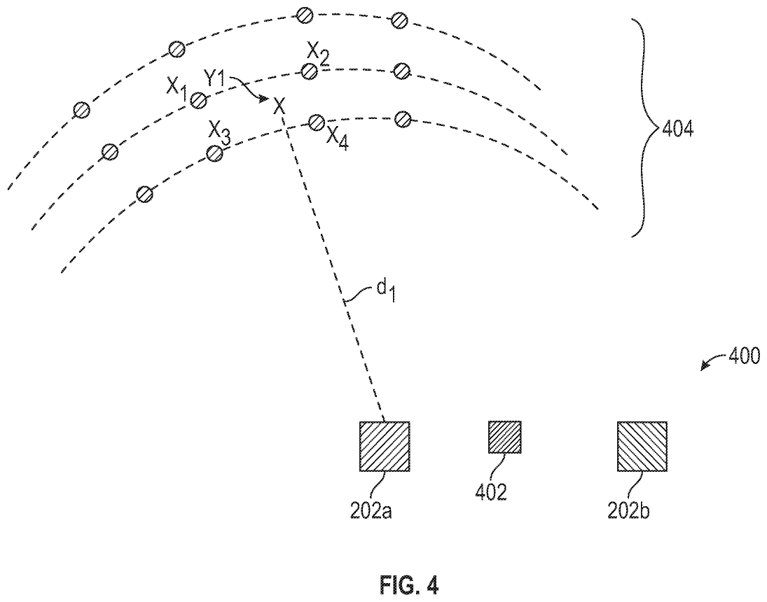

FIG. 4 shows a two-node array 400 including a first node 202a and a second node 202b separated from each other. An array center 402 is shown halfway between first node 202a and second node 202b. A first match filter 404 is associated with the first node 202a for processing far-field measurements associated with the first node 202a. The first match filter 404 is applied to a radar detection in order to obtain an estimate of a parameter measurements from the detection. The first match filter 404 defines a coarse grid over space having a plurality of grid points. The complex values of the grid points match filter are denoted by (x₁, x₂, . . . , x_{N}). Applying the first match filter 404 to the detection provides an estimate of a parameter measurement. In particular, the grid points and their associated complex values can be further processed to obtain an interpolated point for the signal that is on a fine grid at a position between the coarse grid points.

In various embodiments, a signal is received from the object by reflection of the source signal by object 50 located at distance d₁ with respect to the first node 202a. Interpolation determines the location and complex value of the signal by using the coarse grid complex values (x₁, x₂, . . . , x_{N})) for the first match filter 404 and the known positions of the grid points of the first match filter 404. Interpolation is shown in Eq. (1):

y₁₌=(A^{H}A)⁻¹A^{H}a₀x Eq. (1)

where

x=[x₁ x₂ x₃ x₄]^{T} Eq. (2)

and

A=[a₁ a₂ a₃ a₄] Eq. (2)

where a₁, a₂, a₃, and a₄ are vectors of the expected array response for each of the reflection point positions that correspond to the grid points x₁, x₂, x₃ and x₄, respectively, and a₀ is the array response to a reflection point that is at the desired point on the fine grid.

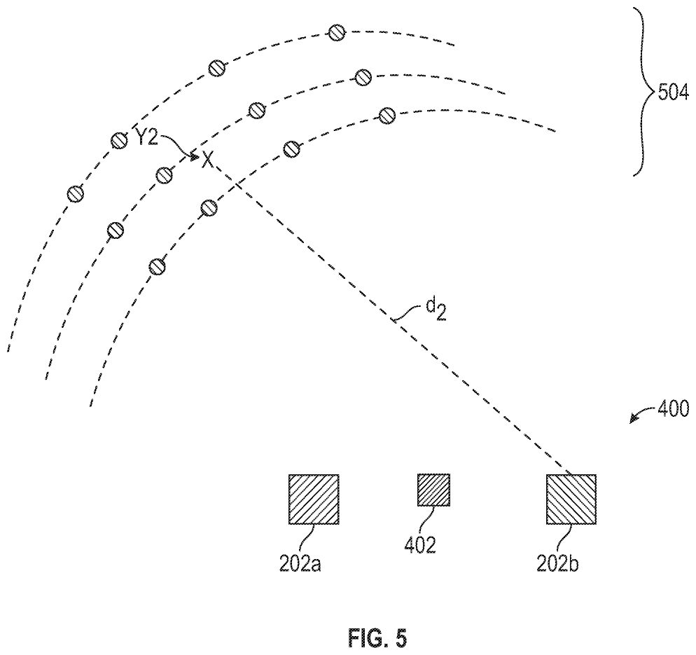

FIG. 5 illustrates a far-field processing for estimating a parameter measurement of the object 50 using a second node 202b of the array 400. A second match filter 504 is associated with the second node 202b. The second match filter 504 is applied to the radar detection in order to obtain a second estimate of a parameter measurement from the detection.

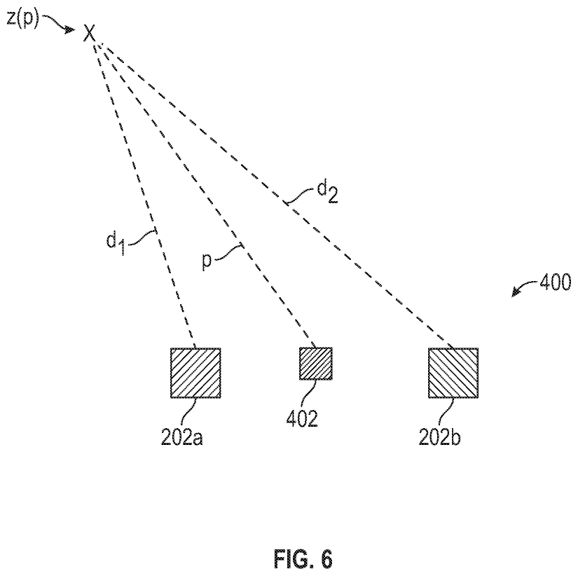

FIG. 6 illustrates a method for obtaining a joint parameter measurement form the first far-field parameter measurement y₁ and the second far-field parameter measurement y₂. The far-field parameter measurements are combined using the Eq. (3) below:

z=y₁exp(j2πd₁/λ)+y₂exp(j2πd₂/λ) Eq. (3)

where d₁ is a distance between the center point of the first node 202a and the reflection point location of the first parameter measurement and d₂ is a distance between the center point of the second node 202b and the reflection point location of the second parameter measurement, λ is the wavelength of the source signal of the radar system.

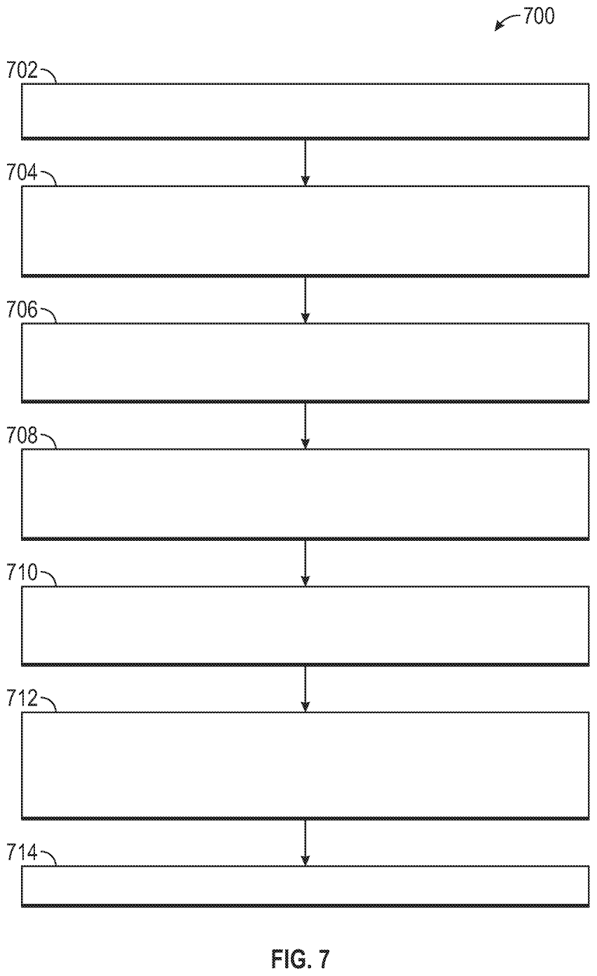

FIG. 7 shows a flowchart illustrating a method 700 of vehicle navigation using the methods disclosed herein. In box 702, the signal is received from an object at a first node and second node of a radar array. In box 704, a first match filter, calculated based on far-field assumptions, associated with the first node is applied to the received signal of the first node, in order to determine parameter measurements for the first node at grid points of a first coarse grid. In box 706, the parameter measurements at the first coarse grid are interpolated to determine a first far-field parameter measurement at a location on a first fine grid that is not on a grid point of the first coarse grid. In box 708, a second match filter, calculated based on far-field assumptions, associated with the second node is applied on the received signal of the second node, in order to determine a parameter measurements for the second node over a second coarse grid. In box 710, the parameter measurements at the second coarse grid are interpolated to determine a second far-field parameter measurement at a location on a second fine grid that is not on a grid point of the second coarse grid. It is to be understood that, in alternate embodiments, the interpolation of the first and second coarse grid parameter measurements can be performed after both first and second coarse grid parameter measurements have been obtained. In box 712, the first far-field parameter measurement is combined with the second far-field parameter measurement using a near-field phase difference correction between the first node and the second node to obtain a joint parameter measurement. In box 714, the vehicle is navigated with respect to the object using the joint parameter measurement.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a radar, comprising:
determining a first far-field parameter measurement for an object for a first node of the radar using sub-nodes of the first node;
determining a second far-field parameter measurement for the object for a second node of the radar using sub-nodes of the second node; and
obtaining a joint parameter measurement for the object by combining the first far-field parameter measurement with the second far-field parameter measurement by correcting for a near-field phase difference between the first node and the second node.

2. The method of claim 1, wherein the first node and the second node of the radar form a near-field aperture, the subnodes of the first node form a far-field aperture and the subnodes of the second node form a far-field aperture.

3. The method of claim 1, further comprising determining first coarse grid parameter measurements for a first match filter associated with the first node and determining second coarse grid parameter measurements for a second match filter associated with the second node.

4. The method of claim 3, further comprising interpolating the first coarse grid parameter measurements to estimate the first far-field parameter measurement at grid location on a first fine grid and interpolating the second coarse grid parameter measurements to estimate the second far-field parameter measurement at a grid location on a second fine grid.

5. The method of claim 1, wherein correcting for the near-field phase difference further comprises applying a near-field correction with respect to a selected location to the first far-field parameter measurement and the second far-field parameter measurement.

6. The method of claim 1, further comprising performing at least one of (i) range FFT; (ii) Doppler FFT; (iii) beamforming to determine at least one of the first far-field parameter measurement and the second far-field parameter measurement.

7. The method of claim 1, further comprising navigating a vehicle with respect to the object using the joint parameter measurement.

8. A radar system, comprising:
a radar array including at least a first radar node and a second radar node, each of the first radar node and the second radar node having a plurality of subnodes; and
a processor configured to:
determine a first far-field parameter measurement for an object for a first node of the radar using sub-nodes of the first node;
determine a second far-field parameter measurement for the object for a second node of the radar using sub-nodes of the second node; and
obtain a joint parameter measurement for the object by combining the first far-field parameter measurement with the second far-field parameter measurement by correcting for a near-field phase difference between the first node and the second node.

9. The radar system of claim 8, wherein the first node and the second node of the radar form a near-field aperture, the subnodes of the first node form a far-field aperture and the subnodes of the second node form a far-field aperture.

10. The radar system of claim 8, wherein the processor is further configured to determine first coarse grid parameter measurements for a first match filter associated with the first node and determine second coarse grid parameter measurements for a second match filter associated with the second node.

11. The radar system of claim 9, wherein the processor is further configured to interpolate the first coarse grid parameter measurements to estimate the first far-field first parameter measurement at a grid location on a first fine grid and interpolate the second coarse grid parameter measurements to estimate the second far-field parameter measurement at a grid location on a second fine grid.

12. The radar system of claim 9, wherein the processor is further configured to applying a near-field correction with respect to a selected location to the first far-field parameter measurement and the second far-field parameter measurement.

13. The radar system of claim 8, wherein the processor is further configured to perform at least one of (i) range FFT; (ii) Doppler FFT; (iii) beamforming to determine at least one of the first far-field parameter measurement and the second far-field parameter measurement.

14. The radar system of claim 8, wherein the processor is further configured to navigate a vehicle with respect to the object using the joint parameter measurement.

15. A vehicle, comprising:
a radar array including at least a first radar node and a second radar node, each of the first radar node and the second radar node having a plurality of subnodes; and
a processor configured to:
determine a first far-field parameter measurement for an object for a first node of the radar using sub-nodes of the first node;
determine a second far-field parameter measurement for the object for a second node of the radar using sub-nodes of the second node;
obtain a joint parameter measurement for the object by combining the first far-field parameter measurement with the second far-field parameter measurement by correcting for a near-field phase difference between the first node and the second node; and
navigate the vehicle with respect to the object using the joint parameter measurement.

16. The vehicle of claim 15, wherein the first node and the second node of the radar form a near-field aperture, the subnodes of the first node form a far-field aperture and the subnodes of the second node form a far-field aperture.

17. The vehicle of claim 15, wherein the processor is further configured to determine first coarse grid parameter measurements for a first match filter associated with the first node and determine second coarse grid parameter measurements for a second match filter associated with the second node.

18. The vehicle of claim 17, wherein the processor is further configured to interpolate the first coarse grid parameter measurements to estimate the first far-field first parameter measurement at a grid location on a first fine grid and interpolate the second coarse grid parameter measurements to estimate the second far-field parameter measurement at a grid location on a second fine grid.

19. The vehicle of claim 15, wherein the processor is further configured to apply a near-field correction with respect to a selected location to the first far-field parameter measurement and the second far-field parameter measurement.

20. The vehicle of claim 15, wherein the processor is further configured to perform at least one of (i) range FFT; (ii) Doppler FFT; (iii) beamforming to determine at least one of the first far-field parameter measurement and the second far-field parameter measurement.
